(19) United States
(12) Patent Application Publication
(10) Pub. No.: US 2006/0183080 A1
(43) Pub. Date: Aug. 17, 2006

(54) Dental treatment kits and methods for forming customized dental trays

(76) Inventors: Vasiliy Nosov, Moscow (RU); Dan E. Fischer, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/719,105

(22) Filed: Nov. 21, 2003

(51) Int. Cl. A61C 5/00; A61C 9/00

(52) U.S. Cl. 433/215; 433/41

(57) ABSTRACT

A kit used to form a customized dental tray from a heat-softenable polymeric material using a person's teeth as a template includes a preformed tray and a color-changing temperature indicator. The color-changing temperature indicator may be attached to or separate from the preformed tray. When heated together, the indicator signals to the user by a color change when the tray has reached a customization temperature range. This signal prevents errors of underheating and overheating common in the customization process.

### BACKGROUND OF THE INVENTION

1. The Field of the Invention

The present invention is in the field of dental trays used to provide a desired dental treatment to a person's teeth. More particularly, the invention relates to preformed dental trays that may be heated and customized to a patient's teeth.

2. The Relevant Technology

Virtually all people desire white or whiter teeth. To achieve this goal, people either have veneers placed over their teeth or have their teeth chemically bleached. In the past, patients who desired to have their teeth bleached had to submit to conventional in-office bleaching techniques. The process generally involves: (1) making an alginate impression of the patient's teeth; (2) making a stone cast or model of the impression; (3) vacuum forming a dental tray from the model, usually from a sheet of thin ethyl vinyl acetate (EVA) material, and trimming to exclude gingival coverage. This method results in a tray that is soft and flexible, that is very accurately customized to the patient's teeth, but the method is time consuming and the resulting tray is expensive.

Because of the high cost of forming in-office customized dental trays, less costly alternatives have been developed. One alternative requires heating a preformed tray, generally in water, which is then fitted or customized to the patient's teeth (e.g. the so-called “boil and bite” tray). A relatively thick, non-custom preformed tray (similar to an athletic mouth guard) made of EVA or polyethylene or other heat softenable polymeric material is submerged in hot or boiling water. Upon removal from the water, the tray is quickly placed inside the patient's mouth. The patient quickly applies contact pressure to make an impression of the biting surfaces of the user's teeth.

Another alternative is a dual tray assembly as disclosed in U.S. Pat. No. 5,616,027 to Jacobs et al. The dual tray assembly is composed of an outer support tray that supports or carries an inner tray made of a heat-softenable polymeric material, typically EVA. In use, the tray assembly is submerged in hot water, wherein the inner tray becomes pliable and moldable and the outer tray remains rigid. The heated assembly is then placed in the mouth of the patient where the inner tray takes an impression of the person's teeth. The generally thinner inner tray results in a final tray that is much thinner and more comfortable to wear compared to conventional “boil and bite” trays which must be sufficiently thick so that they do not need an outer support tray.

With each of these alternatives the customization process involves heating a preformed tray, typically in hot or boiling water. If a tray is not sufficiently heated before customization, the tray will not accurately conform to the patient's teeth, resulting in a less effective treatment and an uncomfortable tray. Another difficulty encountered in this process is that many tray materials, especially thinner materials, tend to shrivel and collapse on themselves if overheated. Besides being damaged, a tray that is heated too long may burn the patient or otherwise be uncomfortable. These difficulties may result in waste and/or user frustration.

In view of the foregoing, there is an ongoing need to provide improved systems and methods for forming a customized dental tray using a person's own teeth as a template.

### BRIEF SUMMARY OF THE INVENTION

The present invention is directed to dental treatment kits including a preformed dental tray and a color-changing temperature indicator. The kit may also optionally include a dental treatment composition, such as a bleaching gel or a desensitizing agent. The preformed dental tray is sized and configured so that it can be placed over at least a portion of a person's upper or lower teeth during a tray customization procedure.

The preformed tray may be of any various designs, including a “boil and bite” preformed tray or a two-part tray as taught in U.S. Pat. No. 5,616,027 to Jacobs (herein specifically incorporated by reference). U.S. patent application Ser. No. 10/225,000 discloses other suitable designs, also herein specifically incorporated by reference. Examples of suitable heat-softenable polymeric materials from which to make the preformed tray include ultra low density polyethylene (“ULDPE”), ethylene-vinyl acetate (“EVA”), ε-polycaprolactone (“PCL”), low density polyethylene (LDPE), other polyethylenes (“PE”), polypropylene (“PP”). Plasticizers and/or flow additives known in the thermoplastic art can be used as desired to modify the properties of the heat-softenable polymeric material used to form the preformed dental tray.

The color-changing temperature indicator may be attached to or separate from the preformed tray. The indicator may include a strip or other structural support and a liquid crystal or polymer attached, impregnated or otherwise associated with the strip or support that changes color when heated to within the customization temperature range. Liquid crystals that change color in response to changes in temperature are referred to as “thermotropic liquid crystals”. Thermotropic liquid crystals include, but are not limited to, cholesterol esters (e.g., cholesterol benzoate), phenyl benzoates, polyesters, and carbohydrate liquid crystals (e.g., cellulose derivatives). One of ordinary skill in the art will be able to select an appropriate color-changing liquid crystal or polymer based on the softening temperature (or temperature ranges) of the dental tray material.

A customized dental tray may be formed using a dental treatment kit containing a preformed dental tray and a color-changing temperature indicator. This is done by heating together a preformed dental tray and a color-changing temperature indicator. The color-changing temperature indicator is designed to change colors when heated to the customization temperature range of the preformed tray. The user monitors the indicator for a change in color, indicating that the preformed dental tray has been heated to within the customization temperature range. The user then removes the dental tray from heating and immediately places the tray over the person's teeth, where an impression of the person's teeth is formed within the dental tray.

The customization temperature range in which a customizable tray becomes plastically deformable is dependent on the material from which the tray is made, which is preferably in a range of about 110° to about 180° F., more preferably in a range of about 120° to about 170° F., and most preferably in a range of about 130° to about 160° F. Upon heating to within the customization temperature range, the tray becomes plastically deformable and moldable so that it can form an impression of the teeth or teeth and gums.

Heating may be accomplished by immersing the preformed tray and color-changing temperature indicator into hot water or by exposing them to other suitable heating means known in the art (e.g., heat gun, oven or torch). The tray will typically reach a customization temperature range and become plastically deformable after being submerged within water heated to a temperature of about 160-212° F. or heated using other appropriate heating means within a prescribed period of time, preferably within about 1-30 seconds, more preferably within about 2-15 seconds, and most preferably within about 4-8 seconds.

When the tray reaches the customization temperature range, the temperature indicator changes color to indicate to the user that the tray has reached a temperature at which customization can occur. At this point, the tray is placed over the person's upper and/or lower teeth and the tray is customized to the person's teeth.

If additional customization is needed, either immediately or later, the tray may be heated and customized as before. The color-changing temperature indicator may optionally be reversible, so that when cooled, it returns to its original color, and when reheated, it changes color again. A reversible color-changing temperature indicator may be reused as many times as desired.

The customized trays formed in this manner are useful for tooth bleaching or other dental treatments. Dental bleaching agents, desensitizing agents, or other dental treatment compositions may be included in the dental treatment kit. Such a composition can be applied to a person's teeth and/or gums by placing the composition into the customized tray and placing the tray over the person's teeth.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary preformed dental tray with an attached color-changing temperature indicator;

FIG. 2 illustrates an alternative preformed dental tray with an attached color-changing temperature indicator;

FIG. 3 illustrates a two part dental treatment tray with an attached color-changing temperature indicator;

FIG. 4 illustrates the preformed dental tray of FIG. 1 with a separate color-changing temperature indicator;

FIGS. 5A-5D illustrate alternative methods of heating a preformed tray together with a color-changing temperature indicator preparatory to making a customized dental tray;

FIG. 6 illustrates the preformed dental tray of FIG. 1 being placed in a patient's mouth during formation of a customized tray;

FIG. 7 illustrates an intermediate customized dental tray being trimmed; and

FIG. 8 illustrates a customized dental tray that has been trimmed and scalloped.

### DETAILED DESCRIPTION OF THE PREFERRED EMBODIMENTS

The present invention provides a dental treatment kit with a preformed dental tray and a color-changing temperature indicator for use in forming customized dental trays. A dental treatment composition, such as a bleaching agent and/or a desensitizing agent may also be provided in such a kit. The preformed dental tray is sized and configured so that it can be placed over at least a portion of a person's upper or lower teeth during a tray customization procedure. Any preformed dental tray that requires heating prior to receiving an impression for customization can be incorporated into the inventive kit. The tray is formed of a heat-softenable polymeric material, which becomes plastically deformable when heated to within a customization temperature range. When plastically deformable, the tray is placed in contact with a person's teeth and formed into a customized dental tray.

The color-changing temperature indicator may be attached to or separate from the preformed tray. The indicator may comprise a strip or other structural support and a liquid crystal or polymer that changes color when heated to within the customization temperature range. If attached to the preformed tray, the color-changing temperature indicator may be either removable or non-removable from the tray.

The color-changing liquid crystal or polymer is typically attached, impregnated or otherwise associated with the strip or other structural support. Color-changing liquid crystals are also referred to as “thermotropic liquid crystals”. Thermotropic liquid crystals include, but are not limited to, cholesterol esters (e.g., cholesterol benzoate), phenyl benzoates, polyesters, and carbohydrate liquid crystals (e.g., cellulose derivatives). One of ordinary skill in the art will be able to select an appropriate color-changing liquid crystal or polymer based on the softening temperature (or temperature range) of the dental tray material.

The color-changing temperature indicator provides a visual indication (by a color change) to the user that the tray is within the customization temperature range. In other words, at ambient temperature, the color-changing temperature indicator is a first color, and when heated to within the customization temperature range of the tray, the indicator changes to a second color. In addition, the color-changing temperature indicator may optionally be capable of changing to a third color when heated to a temperature above which the preformed dental tray may become damaged or cannot be comfortably placed within a person's mouth.

The color-changing temperature indicator may be reversible or irreversible. For a reversible color-changing temperature indicator, if the indicator and tray are allowed to cool to ambient temperature once the indicator has already changed to a second color, the indicator will return to the first color upon cooling to below the customization temperature range. When using a reversible color-changing temperature indicator, the indicator may be used repeatedly, as desired.

The dental treatment kit may further include a dental treatment composition, for example a dental bleaching agent and/or a desensitizing agent. The composition may be preloaded in a syringe for convenient dispensing into the customized tray.

As used herein, the term “preformed dental tray”means a dental tray formed of a heat-softenable polymeric material that may be heated to a customization temperature and then customized. It may include any heat customizable tray designed to be placed over a person's teeth, and may be of various designs. After customization, it may be used for teeth bleaching, administration of fluoride, administration of medications, and other uses.

As used herein, the terms “plastic deformation” and “plastically deformable” refer to a condition in which the tray material becomes sufficiently soft and moldable so that it can form an impression of the teeth or teeth and gums.

As used herein, the term “customization temperature range” refers to a range of temperatures within which the tray material is plastically deformable so that the dental tray may be customized when placed in contact with a person's teeth, but not so soft or flowable that the dental tray shrivels, melts, or is otherwise deformed to the point of preventing formation of a customized dental tray.

As used herein the term “color-changing temperature indicator” refers to a device that when heated, changes colors so as to provide a visual indication that the dental tray is within the customization temperature.

FIG. 1 depicts a kit 100 including a preformed dental tray 102 with an attached color-changing temperature indicator 104 that may be used to make a customized dental tray. The tray 102 comprises a bottom wall 106 having a generally horseshoe-shaped configuration generally conforming to the shape of the person's dental arch. The bottom wall 106 has a generally flat planar profile, although it could be curved. The tray 102 further includes a front side wall 108 and a rear side wall 110 that, together with the bottom wall 106, form tray 102 that is open at the top and that terminates at ends 112. A handle 114 is attached to the tray 102 along an outer surface of the front side wall 108. Color-changing temperature indicator 104 is shown attached to the handle 114, although it could be attached to any surface of the tray.

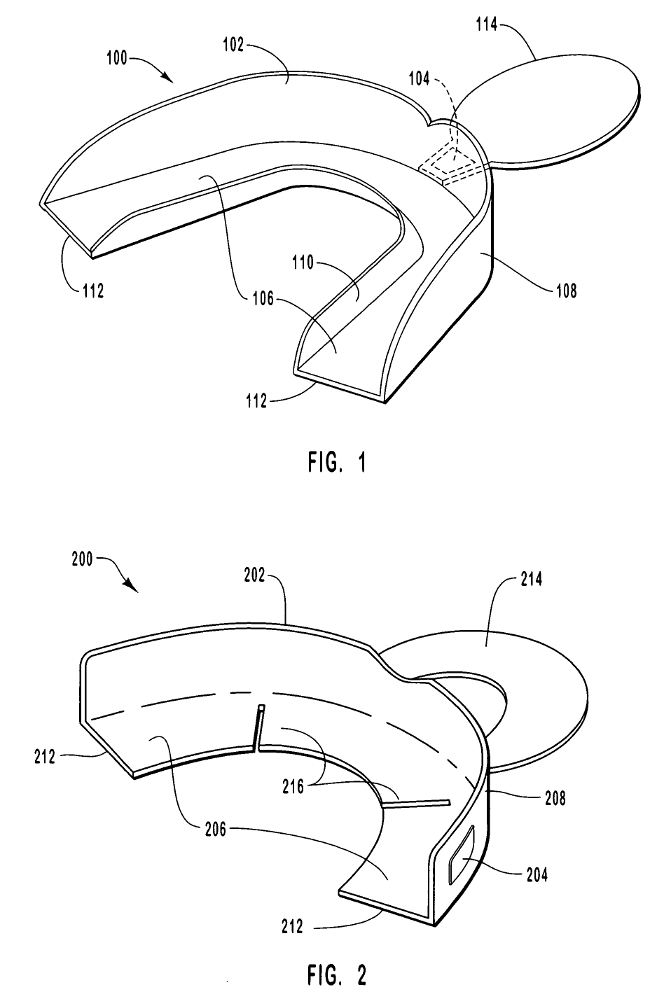

FIG. 2 illustrates an alternative kit 200 including a preformed dental tray 202 with an attached color-changing temperature indicator 204. This tray also includes a horseshoe shaped bottom wall 206, a front wall 208, ends 212, and a handle 214. This embodiment differs from that illustrated in FIG. 1 in that it does not include a rear side wall, which results in an L-shaped tray. Such a tray is useful where treatment of only the labial surface of the patient's teeth is desired. A further difference is that bottom wall 206 may include one or more slots 216, which help maintain proper curvature of bottom wall 206. Color-changing temperature indicator 204 is seen attached to the outside surface of front side wall 208, although it could be attached to any surface of the tray, including the handle 214.

FIG. 3 illustrates a kit 300 that includes a two-part tray assembly 302 as taught by U.S. Pat. No. 5,616,027 with an attached color-changing temperature indicator 304. The two-part tray 302 includes a thin inner tray 306 and an outer support tray 308. The outer support tray 308 is thicker and more rigid than the inner tray and serves to support the inner tray during the heating and customization process. The inner tray 306 nests with the outer support tray 308, and once customization is complete, the inner tray 306 may be separated from the outer support tray 308 and the inner tray may be used for a dental treatment. In the illustrated embodiment, the color-changing temperature indicator 304 is attached to the outer support tray 308.

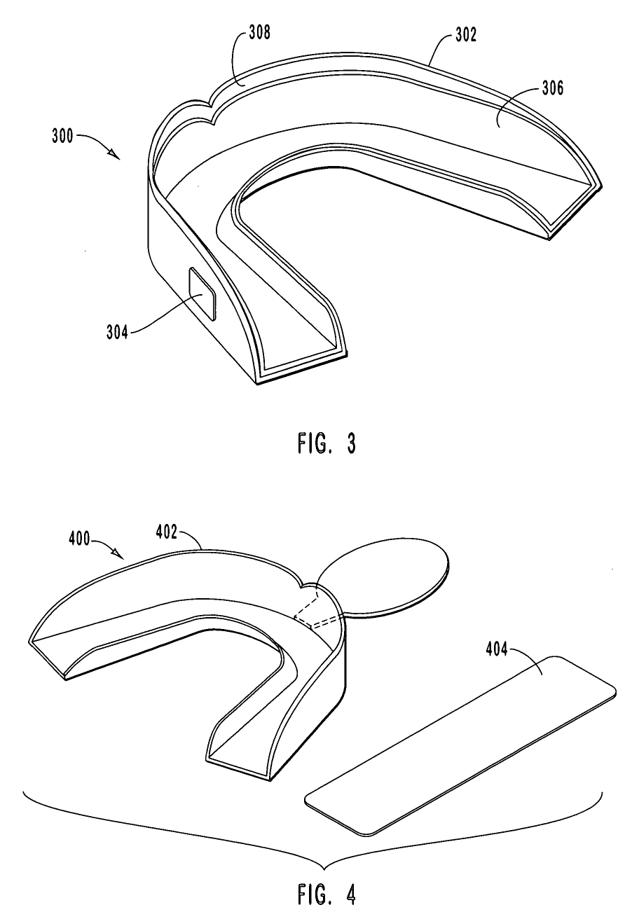

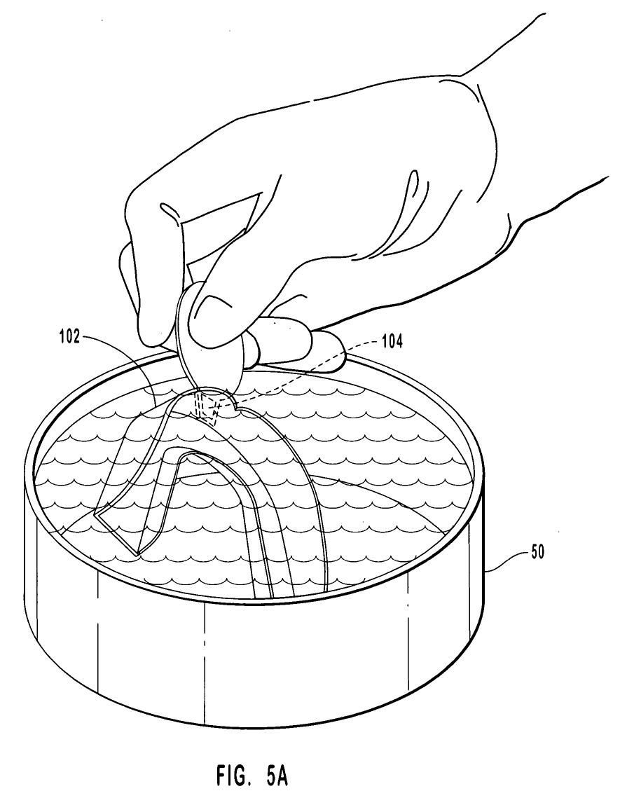

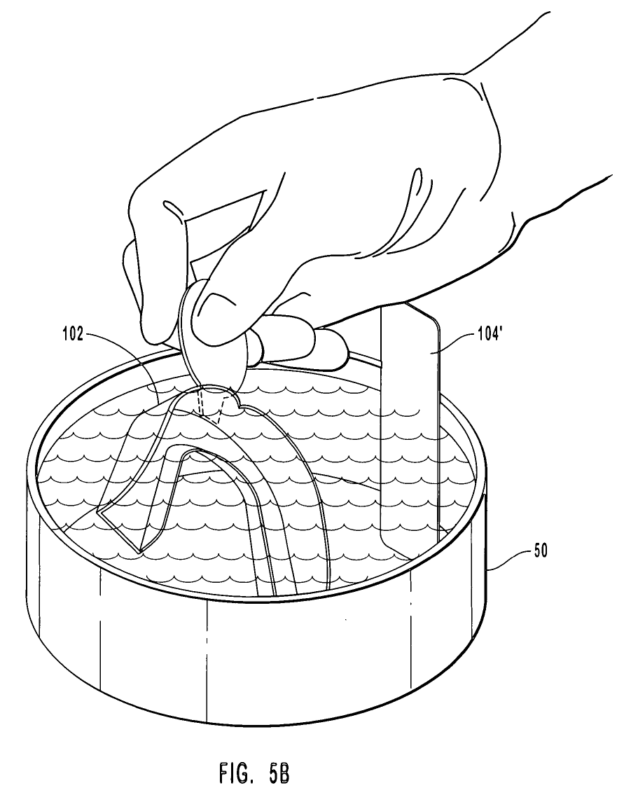

It is not required to attach the color-changing temperature indicator to the preformed tray. FIG. 4 illustrates a kit 400 that includes a preformed dental tray 402 (similar to tray 102 illustrated in FIG. 1) with a separate color-changing temperature indicator 404 that may be used to make a customized dental tray. Whether separate or attached, the color-changing temperature indicator simplifies the process of heating a preformed tray, and reduces the waste and frustration resulting from over and underheating of the preformed tray.

The tray is designed and formulated so as to soften when heated to a customization temperature range, preferably in a range of about 110° to about 180° F., more preferably in a range of about 120° to about 170° F., and most preferably in a range of about 130° to about 160° F. Upon heating to an appropriate temperature, the tray becomes plastically deformable and moldable so that it can be customized when placed in contact with a person's teeth.

The preformed tray can be made of any appropriate heat-softenable polymeric material that is able to soften within a predetermined customization temperature range. One suitable material is ultra low density polyethylene (ULDPE), which can be used alone or in combination with other polymers, such as polypropylene (PP), ethylene vinyl acetate (EVA), polycaprolactone (PCL), low density polyethylene (LDPE), and other polyethylenes (PE). Other materials such as LDPE, EVA, PCL, PP, and PE can be used by themselves or blended to make a preformed dental tray. Flow additives, fillers, and plasticizers may be added as desired.

Examples of suitable ULDPE materials include various polymers sold under the general trade name Attane® by Dow Chemical. An example of a suitable EVA material is Elvax® 250, available from Dupont. An example of a suitable PCL material is Capra® 650 from Solvoy-Interox. Other heat-softenable polymeric materials and blends used in making dental trays are disclosed in U.S. Pat. No. 5,769,633 to Jacobs et al., U.S. Pat. No. 5,051,476 to Uji et al., and U.S. Pat. No. 6,089,869 to Schwartz. For purposes of disclosing heat-softenable polymeric materials that can be made into preformed dental trays, the foregoing patents are incorporated herein by reference.

The preformed tray is customized by heating together the tray and the color-changing temperature indicator. The tray and indicator are easily heated by immersing into hot water or by otherwise exposing them to other suitable heating means known in the art (e.g., heat gun, oven, torch, etc). The color-changing temperature indicator will change from a first color to a second color once the customization temperature range has been reached. The user monitors the indicator to determine when the preformed tray has been heated to within the customization temperature range. Once the indicator has changed color, the preformed tray is removed from the water bath or other heat source and placed over the person's teeth. At this temperature, the preformed tray is plastically deformable and will receive an impression of the person's teeth, yielding a customized dental tray. This process will now be described in more detail with reference to the drawings.

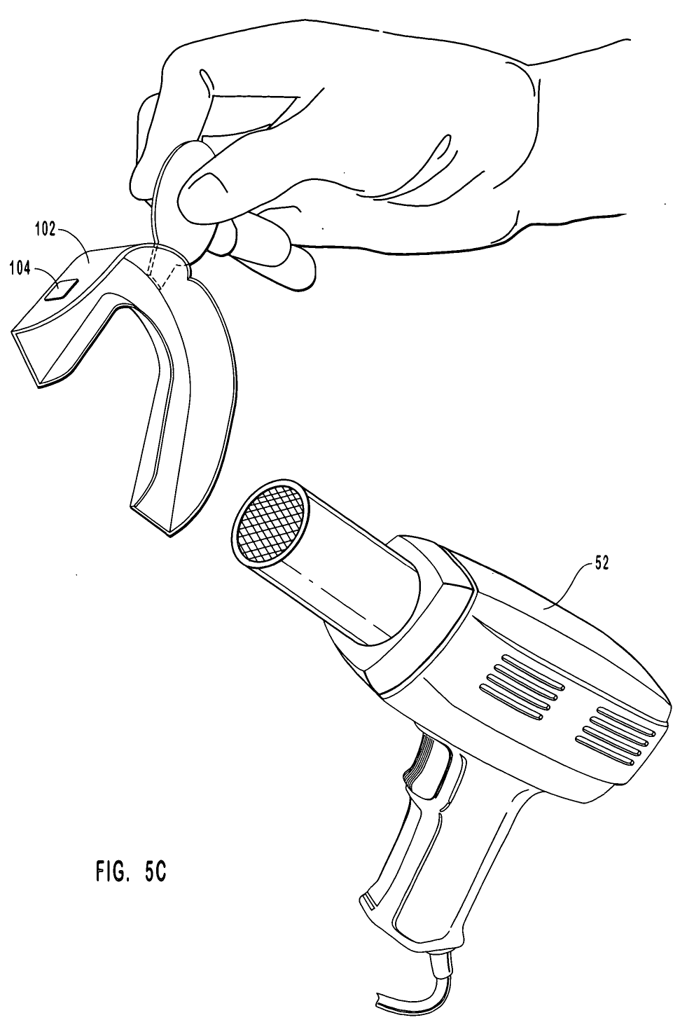

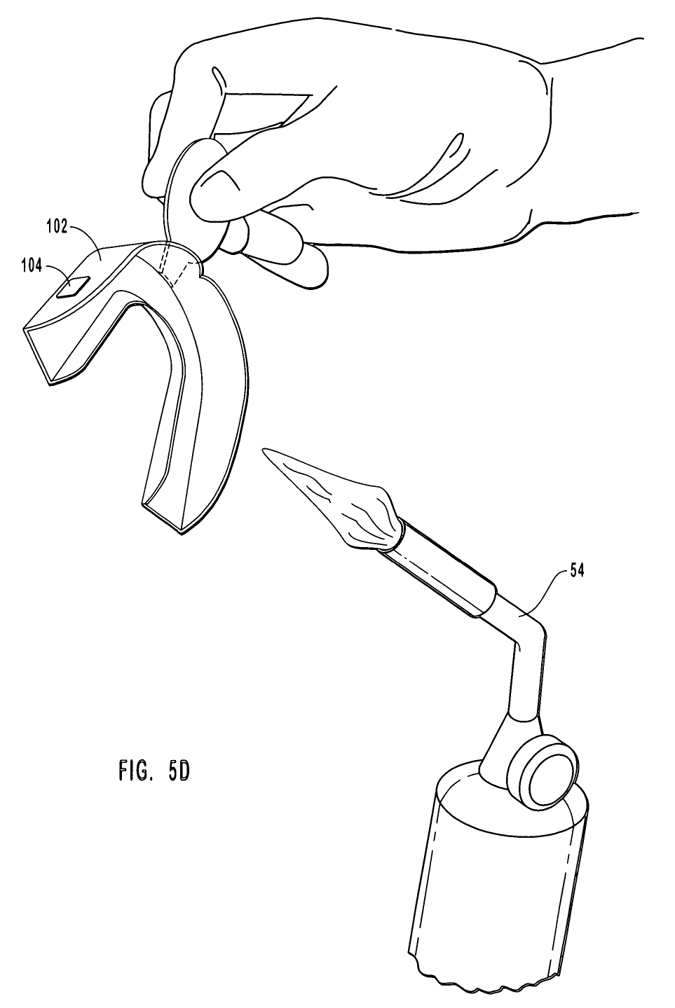

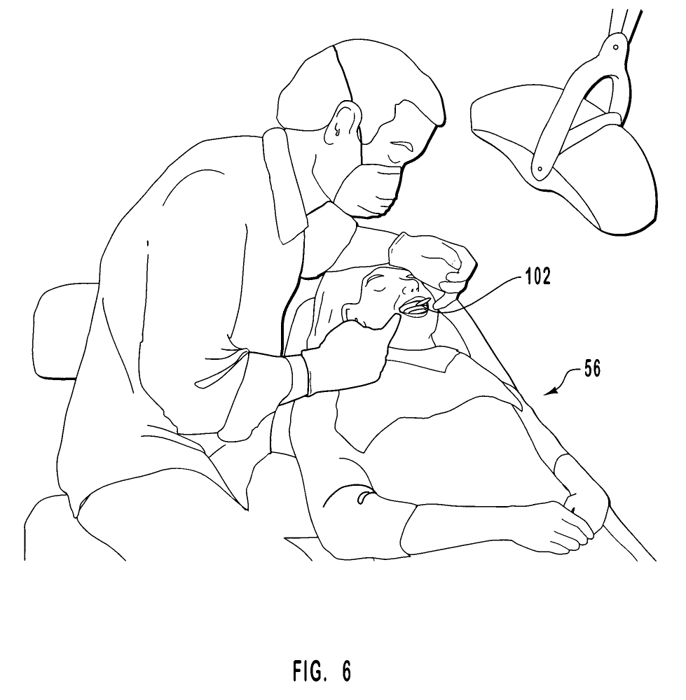

Reference is now made to FIGS. 5A-5D, which depict various methods for heating together a preformed tray 102 and a color changing temperature indicator 104 prior to forming the customized dental tray. Although the following figures and description illustrate operation of the invention with tray 102, the description is not meant to be limiting in any way, but is rather meant to illustrate operation of the invention with any tray requiring heating prior to customization. FIG. 5A depicts tray 102 (same as tray 102 illustrated in FIG. 1) immersed in a bath 50 of hot or boiling water or other suitable liquid. Color-changing temperature indicator 104 is immersed in the water along with tray 102. When the tray reaches a customization temperature range, indicator 104 changes from a first color to a second color, signaling the user that the tray may be removed from the bath for customization.

FIG. 5B illustrates the same tray 102 as seen in FIG. 5A, but here the color-changing temperature indicator 104′ is separate from the tray 102. Both are heated together in the bath 50 of hot or boiling water or other suitable liquid. When the tray reaches a customization temperature range, indicator 104′ changes from a first color to a second color, signaling the user that the tray may be removed from the bath for customization.

FIG. 5C depicts the alternative use of a heat gun 52 to heat together the preformed dental tray 102 and attached color-changing temperature indicator 104. FIG. 5D depicts the alternative use of a torch 54 to heat together the preformed dental tray 102 and attached color-changing temperature indicator 104. When using these alternative heat sources, care should be taken to heat the tray evenly, such as by moving the tray and/or heat source back and forth to avoid heating a single area to the exclusion of other areas.

Referring now to FIG. 6, when the color-changing temperature indicator 104, 104′ changes color (providing a visual indication that tray 102 has been heated sufficiently so as to assume a plastically deformable condition), the tray 102 is inserted into the mouth of a person 56 over the upper or lower teeth and the person 56 closes his or her mouth. The tray is plastically deformed (i.e., molded and formed) so as to conform and correspond to at least a portion of the person's teeth.

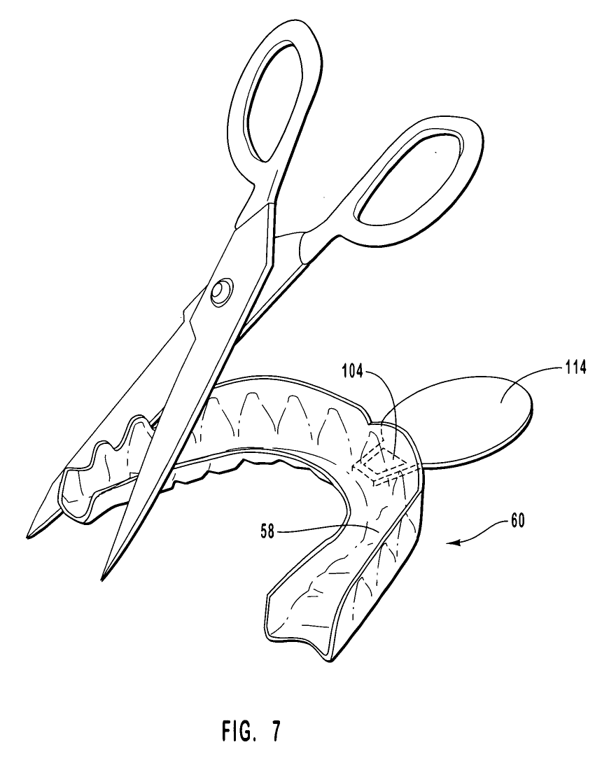

After the preformed tray 102 has been adapted so as to correspond to the person's teeth and has remained in the person's mouth for a sufficient period of time, it will naturally begin to cool. After the tray 102 has been customized so as to form an impression 58 within the intermediate customized tray 60 (FIG. 7) and is no longer plastically deformable, it is taken out of the mouth. It may be further cooled as desired, such as by placing the intermediate customized tray 60 in cold water or by letting it cool to room temperature. When cooled sufficiently, the impression 58 within the intermediate customized tray 60 (FIG. 7) will become permanent. That is, the tray material can then be deformed to the extent that it is flexible and resilient but will return to its original customized shape upon removal of the deformation force. If additional forming is needed, either immediately or later, the customized tray may be reheated so as to become plastically deformable, formed, and then cooled as describe above. If the color-changing temperature indicator is reversible, during any subsequent reheating and recooling, the indicator will continue to function.

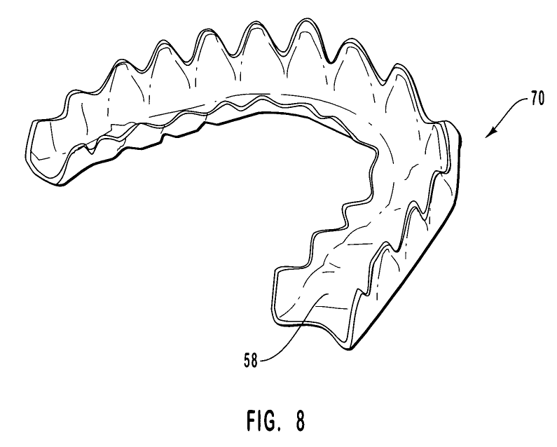

As shown in FIG. 7, once formed, the intermediate customized tray 60 can be trimmed as desired, including removal of handle 114, to yield a finished customized tray of a desired shape (see FIG. 8). In one embodiment, the customized dental tray can be trimmed so as to terminate at or shy of the gingival margin on both frontal and lingual surfaces. It may be desirable to scallop or trim the customized dental tray up and around interdental papilla so that the finished tray does not overlap them so as to achieve maximum patient comfort.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A kit used to form a customized dental tray from a heat-softenable polymeric material using a person's teeth as a template, the kit comprising:
a preformed dental tray sized and configured so that it can be placed over at least a portion of a person's upper or lower teeth during a tray customization procedure, the dental tray comprising a heat-softenable polymeric material having a customization temperature range within which the polymeric material is plastically deformable so that the dental tray can be customized when placed in contact with a person's teeth but not so soft or flowable that the dental tray shrivels, melts or is otherwise deformed to the point of preventing formation of a customized dental tray; and
a color-changing temperature indicator that, when heated together with the preformed dental tray, changes colors so as to provide a visual indication that the dental tray is within the customization temperature range.

2. A kit as defined in claim 1, wherein the heat-softenable polymeric material comprises at least one member selected from the group consisting of low density Mpolyethylene, ultra low density polyethylene, other polyethylenes, ethylene vinyl acetate, polycaprolactone, and polypropylene.

3. A kit as defined in claim 1, wherein the preformed dental tray does not itself change color when heated to within the customization temperature range.

4. A kit as defined in claim 1, wherein the customization temperature range is from about 110° to about 180° F.

5. A kit as defined in claim 1, wherein the customization temperature range is from about 120° to about 1700° F.

6. A kit as defined in claim 1, wherein the customization temperature range is from about 130° to about 160° F.

7. A kit as defined in claim 1, wherein the color-changing temperature indicator is removably attached to the preformed dental tray.

8. A kit as defined in claim 1, wherein the color-changing temperature indicator is non-removably attached to the preformed dental tray.

9. A kit as defined in claim 1, wherein the color-changing temperature indicator is separate from the preformed dental tray

10. A kit as defined in claim 1, wherein the color-changing temperature indicator reversibly changes color when heated to within the customization temperature range.

11. A kit as defined in claim 1, wherein the color-changing temperature indicator irreversibly changes color when heated to within the customization temperature range.

12. A kit as defined in claim 1, wherein the color-changing temperature indicator comprises at least one liquid crystal that changes color when heated to within the customization temperature range.

13. A kit as defined in claim 1, wherein the color-changing temperature indicator changes from a first color to a second color when heated to within the customization temperature range.

14. A kit as defined in claim 13, wherein the color-changing temperature indicator changes to a third color when heated to a temperature above which the preformed dental tray may become damaged or cannot be comfortably placed within a person's mouth.

15. A kit as defined in claim 1, wherein the color-changing temperature indicator changes from white to at least one of black or gray when heated to within the customization temperature range.

16. A kit as defined in claim 1, further comprising at least one dental treatment composition preloaded within a syringe.

17. A kit as defined in claim 16, wherein the dental treatment composition comprises at least one of a dental bleaching agent or a desensitizing agent.

18. A kit as defined in claim 1, further comprising an outer support tray into which the preformed dental tray is placed when the dental tray is heated and customized.

19. A kit used to form a customized dental tray from a heat-softenable polymeric material using a person's teeth as a template, the kit comprising:
a preformed dental tray sized and configured so that it can be placed over at least a portion of a person's upper or lower teeth during a tray customization procedure, the dental tray comprising a heat-softenable polymeric material having a customization temperature range within which the polymeric material is plastically deformable so that the dental tray can be customized when placed in contact with a person's teeth but not so soft and flowable that the dental tray shrivels, melts or is otherwise deformed to the point of preventing formation of a customized dental tray, wherein the preformed dental tray does not change color when heated to within the customization temperature range;
a color-changing temperature indicator comprising at least one liquid crystal that, when heated together with the preformed dental tray, changes colors so as to provide a visual indication that the dental tray is within the customization temperature; and
at least one dental treatment composition preloaded within a syringe.

20. A kit as defined in claim 19, wherein the dental treatment composition comprises at least one of a dental bleaching agent or a desensitizing agent.

21. A method of forming a customized dental tray, comprising:
(a) heating together
(i) a preformed dental tray comprising a heat-softenable polymeric material to within a customization temperature range in which the polymeric material is plastically deformable so that the dental tray can be customized when placed in contact with a person's teeth but not so soft and flowable that the dental tray shrivels, melts or is otherwise deformed to the point of preventing formation of a customized dental tray; and
(ii) a color-changing temperature indicator that, when heated together with the preformed dental tray, changes colors so as to provide a visual indication that the dental tray is within the customization temperature;
(b) monitoring the color-changing temperature indicator to determine when the preformed dental tray has been heated to within the customization temperature range;
(c) placing the dental tray over the person's teeth when heated to within the customization temperature range; and
(d) forming an impression of the person's teeth within the dental tray that substantially corresponds to at least a portion of the person's teeth in order to yield a customized dental tray.

22. A method as defined in claim 21, wherein the preformed dental tray is heated using hot water.

23. A method as defined in claim 21, wherein the preformed dental tray is heated using a heat gun.

24. A method as defined in claim 21, wherein the preformed dental tray is heated using a torch.

25. A method as defined in claim 21, further comprising removing the customized dental tray from the person's teeth after the impression has been formed and the dental tray has cooled sufficiently so as to retain the impression.

26. A method as defined in claim 25, further comprising trimming and scalloping the customized dental tray so that it does not significantly overlap the person's gingival margin when placed over the person's teeth.
